(19) United States
(12) Patent Application Publication
(10) Pub. No.: US 2012/0218075 A1
(43) Pub. Date: Aug. 30, 2012

(54) METHODS AND APPARATUS TO CONTROL ACCESS

(76) Inventor: Thomas Casey Hill, Crystal Lake, IL (US)

(21) Appl. No.: 13/036,874

(22) Filed: Feb. 28, 2011

(51) Int. Cl. G06F 7/04

(52) U.S. Cl. 340/5.61

(57) ABSTRACT

Methods and apparatus to support personal information management are described. One example method includes receiving personal information of a user from a mobile device through close-proximity communication, wherein the personal information includes government-issued credentials of the user; accessing verification information related to the personal information; and verifying the personal information based on a comparison of the verification information and the personal information. Other implementations are possible.

### FIELD OF THE DISCLOSURE

This disclosure relates generally to physical access control and, more particularly, to methods and apparatus to control access.

### BACKGROUND

Conventionally, access control to physical areas is carried out using proximity cards or other devices separate from other devices already carried by a user. Conventional devices either allow or do not allow a user to access certain physical areas based on credentials, which may present security gaps.

### BRIEF DESCRIPTION OF THE DRAWINGS

FIG. 1 is a plan view representation of a building having different areas to which a user may desire physical access using a mobile device that interacts with access control systems.

FIG. 2 is a block diagram of an example interaction between a mobile device and an access control system to obtain physical access to an area of FIG. 1.

FIG. 3 is a diagram of an example mobile device for use in the system of FIG. 1 and FIG. 2.

FIG. 4 is a diagram of an example access control system for use in the system of FIG. 1 and FIG. 2.

FIG. 5 is a flow diagram of an example process that may be carried out by the mobile device of FIG. 1, FIG. 2, and FIG. 3.

FIG. 6 is a flow diagram of an example process that may be carried out by an access control system of FIG. 1, FIG. 2, and FIG. 4.

FIG. 7 is a block diagram of an example mobile device in accordance with the disclosure.

FIG. 8 is a block diagram of example hardware and software that may be used to implement the block diagrams and processes described above.

### DETAILED DESCRIPTION

As described below, close-proximity communication systems, such as radio frequency identification (RFID), near-field communication (NFC), and the like, can be used by a mobile device, such as a smartphone, to interoperate with an access control system to allow or deny physical access by a user to one or more physical locations. In this manner, the mobile device may be used to obtain access to one or more physical areas of, for example, a building, a plant, or any other structure or area to which physical access is restricted based on access credentials.

In one example, access to a second physical location is dependent on a user having obtained access to a first physical location. One method may include requesting from a mobile device using close-proximity communication or communications authorization to access a first physical area; receiving at the mobile device using close-proximity communication authorization to access the first physical area; requesting from the mobile device using close-proximity communication authorization to access a second physical area inside the first physical area; and receiving at the mobile device using close-proximity communication authorization to access the second physical area, wherein receipt of the authorization to access the second physical area is dependent upon prior receipt of the authorization to access the first physical area. In some examples, the first authorization may be time-stamped so that the first authorization may be evaluated to determine if it should be trusted when determining if authorization to the second physical area should be granted.

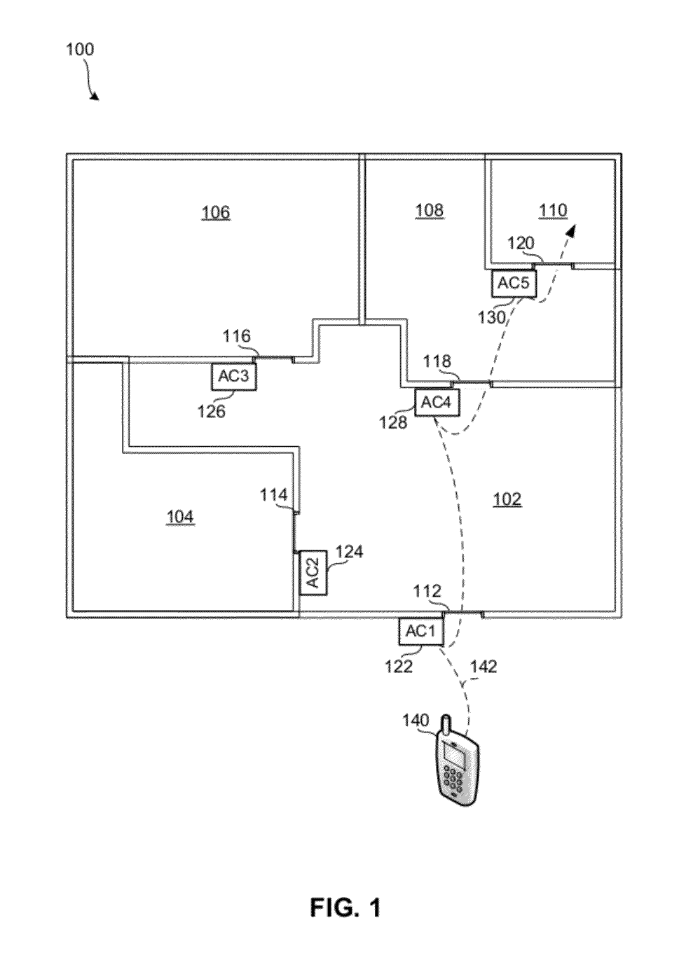

FIG. 1 depicts a building 100 having different areas 102, 104, 106, 108, and 110 to which a user may desire physical access. In one example, the area 102 may be a lobby or entrance of the building 100. From the area 102, the areas 104, 106, and 108 may be accessed. The area 110 lies within the area 108. Locked doors 112, 114, 116, 118, and 120 prevent unauthorized access to areas 102, 104, 106, 108, and 110, respectively. To facilitate access control to the areas 102, 104, 106, 108, and 110, the locked doors, 112, 114, 116, 118, and 120 are respectively provided with access control systems, AC1-AC5, which are referred to using reference numerals 122, 124, 126, 128, and 130. A user may utilize a mobile device 140, such as a smartphone, a cellular telephone, or any other suitable device having close-proximity communication functionality, such as NFC, RFID, or any other technology that enables the mobile device 140 to interact with the access control systems 122, 124, 126, 128, and 130. Further detail regarding the mobile device 140 and the access control systems 122, 124, 126, 128, and 130 is provided below.

In one example operation, the user of the mobile device 140 desires access to the area 110 by following the path shown by the dotted line 142. In particular, to obtain access to the area 102, the mobile device 140 is placed near the access control system 122, which obtains information from the mobile device 140 through close-proximity communication. The information provided by the mobile device 140 may include a history of areas accessed by the mobile device 140 and other credentials or identification. Based on the information provided by the mobile device 140, the access control system 122 allows the user to open the door 112 to access area 102. As part of the authorization process, the access control system 122 may write information, such as access authorization information or other information to the mobile device 140 or any other storage area associated with the mobile device 140.

The user proceeds through the area 102 to the access control system 128 associated with the door 118 and places the mobile device 140 near the access control system 128. Through close-proximity communication the access control system 128 obtains information including an access history from the mobile device 140. The access history may include records of prior accesses by the mobile device 140, including the access recently granted by the access control system 122. The access control system 128 determines if the mobile device 140 user is allowed access to the area 108 by checking access credentials, but also by checking the access history provided by the mobile device 140 to ensure that the mobile device 140 was granted access by the access control system 122. If the credentials and the access history are proper (i.e., the mobile device 140 was previously granted access by the access control system 122), the user of the mobile device 140 is granted access to the area 108. Thus, the access control system 128 may require that the mobile device 140 was previously granted access to the area 102 before access is granted to the area 108.

The process of obtaining access to the area 110 is similar to obtaining access to the area 108. That is, the mobile device 140 is placed near the access control system 130 and the mobile device 140 provides that access control system 130 with an access history, which would now include accesses granted both by the access control system 122 and the access control system 128, and any other credentials. If the access history and the credentials are proper, the access control system 130 grants access to the area 110 through the door 120.

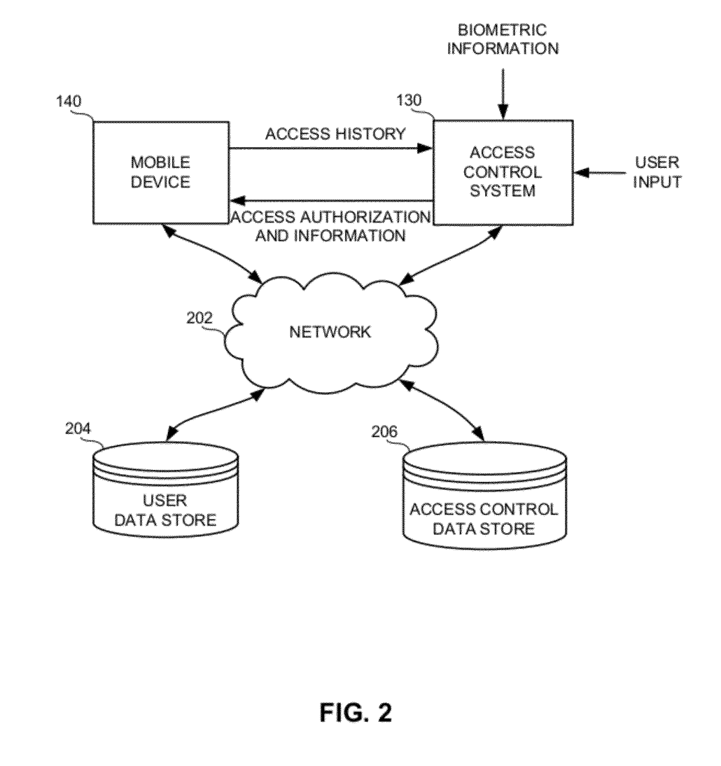

FIG. 2 depicts a block diagram of interaction between the mobile device 140 and the access control system 130. The mobile device 140 and the access control system 130 may each be coupled to a network 202, which may be further coupled to a user data store 204 and an access control data store 206.

The mobile device 140 may be a smartphone, a cellular telephone, a tablet computer, a laptop computer, or any other suitable device. The mobile device 140 may exchange information with the access control system 130 using any suitable communication technique. For example, the mobile device 140 may transmit information such as access history to the access control system 130 and/or credentials and receive information such as access authorization using, for example, NFC, RFID, Bluetooth, wireless fidelity (WIFI), or any other suitable communication technique. The mobile device 140 may store information, such as access history, credentials, authorizations, and the like, of the user of the mobile device 140. Additionally, the mobile device 140 may store information related to individuals that are not the user of the mobile device 140, but are accompanying the user of the mobile device 140. Alternatively, rather than the mobile device 140 storing the information and access history, the mobile device 140 may store one or more links to the information and access history, wherein the information and access history are stored separate from the mobile device 140 and are accessed by the mobile device 140 over the network 202. The information stored in the mobile device 140 may be input to the mobile device 140 through close-proximity communication (e.g., NFC), bar code scanning, manual entry, or by any other suitable method or technique.

The access control system 130 may be a terminal, a computer, a kiosk, or any suitable configuration that is configured to receive and verify information, which may include access history, from the mobile device 140. The access control system 130 may be portable or may be a fixed installation. The access control system 130 may be operated by a private security firm or organization, a government official, such as a police officer, an immigration or border officer, etc. The access control system 130 may, for example, display the information received from the mobile device 140 and allow an official, such as, for example, a security official, an immigration officer or a police officer, to verify such information while conversing with the user of the mobile device 140. Additionally or alternatively, the access control system 130 may use information from the mobile device 140 as a key to retrieve additional information from an alternate source that may be used to verify the information provided by the mobile device 140. The access control system 130 may also receive biometric information from the user of the mobile device 140 and may use such information to verify the information provided by the mobile device 140 and/or verify the identity of the person currently using the mobile device 140. The verification may also receive user input from, for example, an official, through a user input.

The information transferred from the mobile device 140 to the access control system 130 may be information such as, access history, credentials, government-issued identification, etc., related to a user of the mobile device 140. For example, the information may be passport information and/or driver's license information and/or historical information. The access control system 130 may verify the information provided by the mobile device 140, as well as the identity of the person currently using the mobile device 140, to verify that the user matches the information provided by the mobile device 140.

Information transferred from the access control system 130 to the mobile device 140 may be information that updates the information in the mobile device 140. For example, the information provided to the mobile device 140 from the access control system 130 may be access authorization, which may include time stamps, etc. Alternatively, the information may be additional information provided by the access control system 130 to the mobile device 140. The information update may include, but is not limited to, directions or maps of the building 100 or other information related to the building, etc.

The network 202 may be implemented using the Internet, a local area network (LAN), a wide network (WAN), or any other network. Additionally, the network 202 may be a collection of networks that collectively form the network 202. The network 202 may be a public or a private network.

The user data store 204, which is accessible by the network 202 may be located on a server inside a secure network. The user data store 204 may store personal information, credentials, access history, government-issued information, and the like related to the user of the mobile device 140. In one example, the mobile device 140 may use a secure connection to the user data store 204 to access the information (e.g., personal information, credentials, access history, etc.) of the user. Such a secure connection may be implemented using a virtual private network (VPN) connection, a public/private key system, or the like.

The access control data store 206 may store information related to the user of the mobile device 140, wherein such information is not necessarily accessible by the user. For example, the access control data store 206 may be a private or governmental database that is accessible only by officials so that the information in the access control data store 206 is governmentally certified or otherwise certified to be accurate and, thus, may be used to verify information provided by the mobile device 140 to the access control system 130. The access control system 130 may access the access control data store 206 through any suitable wired or wireless connection, which may include the use of encryption, VPN(s), public/private keys, or the like.

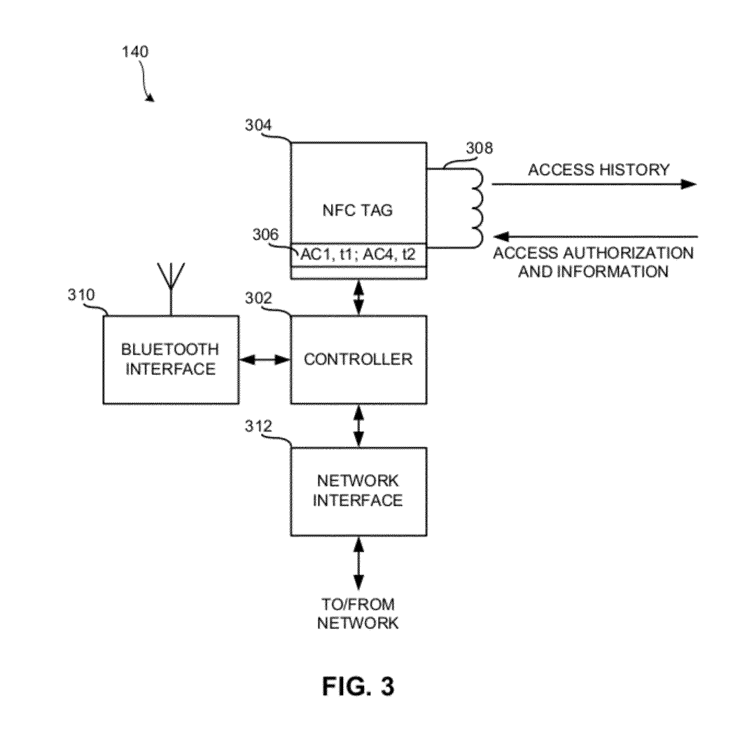

Further detail regarding aspects of the mobile device 140 is shown in FIG. 3. The mobile device 140 includes a controller 302 that is connected to a close-proximity communication device, such as an NFC tag 304.

The controller 302 may be implemented using any suitable microcontroller or microprocessor capable of executing instructions. Additionally, the controller 302 may include hardware implementations, such as application-specific integrated circuits (ASIC), programmable logic devices (PLDs), or any other suitable logic device or devices.

The NFC tag 304 includes memory 306 and an antenna 308. In one example, the NFC tag 304 is implemented according to the International Standards Organization standard ISO 14443. Implementation according to other standards is possible. The memory 306 may store information related to the user of the mobile device 140, such as personal information, credentials, authorizations, historical information, access history, etc., which may be transferred to the access control system 130 upon the NFC tag 304 being interrogated. In the example shown in FIG. 3, the memory 306 stores an access history listing authorizations AC1 and AC4 and time stamps t1 and t2, which indicate that the mobile device 140 was previously authorized by the access control system 122 and the access control system 128 at times t1 and t2, respectively. Alternatively, rather than the access history being stored in the memory 306, the access history may be stored in the access control data store 206 and accessed via the network 202.

In addition, the NFC tag 304 may receive information updates that are provided by the access control system 130. For example, if authorization is granted to the mobile device 140 by the access control system 130, the access control system 130 may provide the NFC tag 304 with an indication of AC5 and a time stamp of t3, to indicate that the mobile device 140 was authorized to access area 110 at time t3. Access authorizations that are denials may also be transferred to, and stored in, the NFC tag 304. The information may be stored in the memory 306 of the NFC tag 304 and/or may be transferred to one or more data stores (e.g., the user data store 204) across the network 202. While the close-proximity communication device is described as being an NFC tag 304, other types of close-proximity communication devices may be utilized instead of, or in addition to, the NFC tag 304.

The NFC tag 304 may store information or may store pointers to information that may be retrieved over the network by the controller 302 via a Bluetooth interface 310 or over a network interface 312. In some examples, all the information may be stored across a network, or the NFC tag 304 may store information and may store pointers to information.

The network interface 312 may be implemented using any wired or wireless communication interface. For example, the network interface 312 may be implemented using an Ethernet connection, or any other wired connection. Alternatively, the network interface 312 may be implemented using a WIFI interface, a cellular modem, which may be a second generation (2G) and/or third generation (3G) and/or fourth generation (4G) cellular modem, or the like, and/or any other wireless network interface. Although shown as having a single network interface 312 the mobile device 140 may include several different network interfaces using one or more different wireless access technologies.

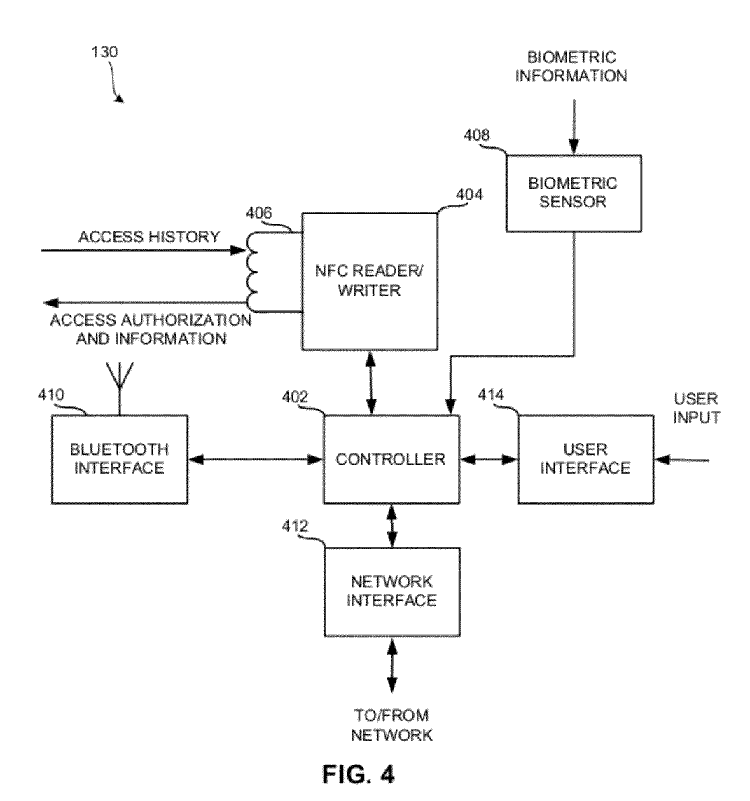

In one example, the access control system 130, which is shown in the example of FIG. 4, includes a controller 402 that is coupled to a close-proximity communication device, such as an NFC reader/writer 404 including an associated antenna 406. The access control system 130 also includes a biometric sensor 408, a Bluetooth interface 410, a network interface 412, and a user interface 414.

The controller 402 may be implemented using any suitable microcontroller or microprocessor capable of executing instructions. Additionally, the controller 402 may include hardware implementations, such as application-specific integrated circuits (ASIC), programmable logic devices (PLDs), or any other suitable logic device or devices.

The NFC reader/writer 404 is configured to interrogate, send commands and information to, and receive information from the NFC tag 304 of FIG. 3. In one example, the NFC reader/writer 404 is implemented according to the International Standards Organization standard ISO 14443. Implementation according to other standards is possible. In one example, the NFC reader/writer 404 is configured to interrogate the NFC tag 304 and receive information from the NFC tag 304. As described above, the information received at the NFC reader/writer 404 from the NFC tag 304 may include information such as access history, credentials, which may be government-issued credentials, etc. Additionally, the NFC reader/writer 404 is configured to send information to the NFC tag 304. As described above, the information may include access authorizations, information, changes to user credentials, history information, such as border crossing history, etc.

The biometric sensor 408 may be optionally included in the access control system 130 to facilitate the reading of biometric information from a user, such as a user of the mobile device 140. In some examples, the biometric sensor 408 may be a fingerprint reader, a retinal scanner, or any other suitable biometric sensor 408 capable of obtaining biometric information that may be used to verify an identity of the user of the mobile device 140.

The Bluetooth interface 410 is configured to facilitate Bluetooth communications with, for example, the mobile device 140, or any other suitably equipped device or component. For example, the Bluetooth interface 410 may facilitate information exchange between the mobile device 140 and the access control system 130, or information exchange between the access control system 130 and any suitable Bluetooth network that may be available.

The network interface 412 may be implemented using any wired or wireless communication interface. For example, the network interface 412 may be implemented using an Ethernet connection, or any other wired connection. Alternatively, the network interface 412 may be implemented using a WIFI interface, a cellular modem, which may be a second generation (2G) and/or third generation (3G) cellular modem, or the like, and/or any other wireless network interface. Although shown as having a single network interface 412 the access control system 130 may include several different network interfaces using one or more different wired or wireless access technologies.

The user interface 414 may include hardware and software to allow a user, such as security personnel or any other suitable user, to interface with the controller 402. For example, the user interface 414 may include a display screen and a keyboard and/or any other suitable input device, such as a touch-screen. The user interface 414 allows a user to see information, such as verification information, that is produced by the controller 402. The user interface 414 also allows the user to provide information, such as text or any other suitable input, to the controller 402.

Block diagrams of apparatus and flowcharts representative of example processes that may be executed to implement some or all of the elements and devices described herein are described below and shown in the drawings. In these examples, the process represented by each flowchart may be implemented by one or more programs comprising machine readable instructions for execution by a processor or controller or any suitable hardware, such as shown in FIGS. 1, 2, 3 and/or 4, and/or any other suitable device.

The one or more programs may be embodied in software or software instructions stored on a tangible medium such as, for example, a flash memory, a CD-ROM, a hard drive, a DVD, or a memory associated with a processor, but the entire program or programs and/or portions thereof could alternatively be executed by a device other than the microprocessor and/or embodied in firmware or dedicated hardware (e.g., implemented by an application specific integrated circuit (ASIC), a programmable logic device (PLD), a field programmable logic device (FPLD), discrete logic, etc.). For example, any one, some or all of the example mobile communications system components could be implemented by any combination of software, hardware, and/or firmware. Also, some or all of the processes represented by the flowcharts may be implemented manually. As used herein, the term tangible computer readable medium is expressly defined to include any type of computer readable storage.

Additionally or alternatively, the example processes described herein may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium.

Further, although the example processes are described with reference to flowcharts, many other techniques for implementing the example methods and apparatus described herein may alternatively be used. For example, with reference to the flowcharts, the order of execution of the blocks may be changed, and/or some of the blocks described may be changed, eliminated, combined, and/or subdivided into multiple blocks. Any of the described blocks may be as implemented as part of an existing system. While the example block diagrams are described as implementing the processes of the flowcharts, the apparatus of the block diagrams may implement any process and, likewise, the processes of the flowcharts may be implemented by any apparatus, device, system, software, or combination thereof.

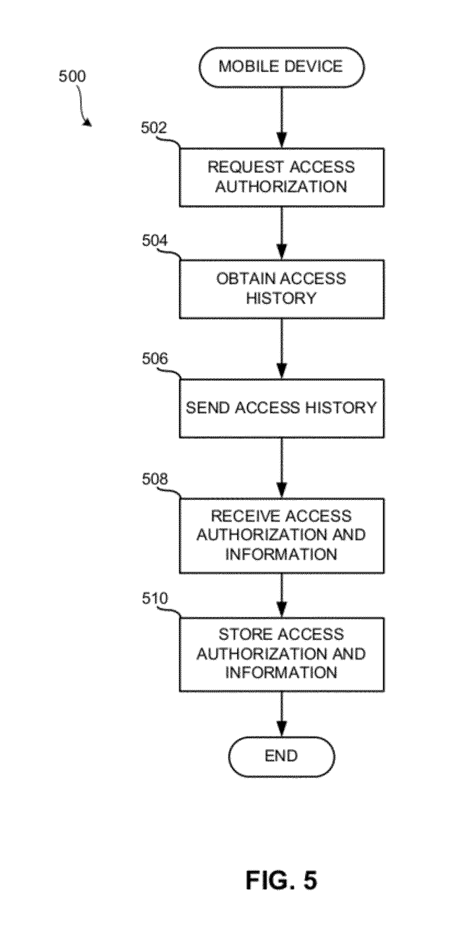

A process 500, as shown in FIG. 5, may be carried out by a mobile device, such as the mobile device 140 of FIG. 1, FIG. 2, and/or FIG. 3. The mobile device 140 when brought near an access control system, such as the access control system 130, requests access authorization to a physical area, such as the area 110 (block 502). The request for access may include the NFC tag 304 remaining in a low power mode until, for example, an interrogation signal is sent by the NFC reader/writer 404 and received at the NFC tag 304, at which time the NFC tag 304 enters an active power mode and requests access.

The mobile device 140 obtains access history (block 504) and provides the same to the NFC reader/writer 404 (block 506). In one example, the access history includes a list of access control systems from which the mobile device 140 has received authorization. In some examples, the access history may include time stamps. As explained above, the access history may be stored in the memory 306 of the NFC tag 304, or may be stored in a data store, such as the user data store 204, and retrieved over a network. In addition to providing the access history, the mobile device 140 may provide an indication of the identity of the user of the mobile device 140, credentials of the user, or any other suitable information that may be uses for the purpose of verifying that access should be granted to a user.

In another example, the mobile device 140 may provide to the access control system 130 only an identifier associated with the mobile device 140. In such an example, the access history may be stored in, for example, the access control data store 206 in association with the identifier of the mobile device 140. In such a manner, each access control system could report access by the mobile unit 140 to the access control data store 206 and that information could be retrieved by the access control system 130.

The mobile device 140 receives an access authorization and, optionally, additional information from the access control system 130 (block 508). The access authorization may include information granting or denying access to the area 110. The additional information may include maps or directions related to the building 100, which may include identification of other access control systems located within the building. The additional information may also include emergency contact or exit information, or any other suitable information.

The mobile device 140 stores the access authorization and, optionally, the additional information (block 510) either in the memory 306 of the NFC tag 304, in the user data store 204, or in any other suitable storage location either local to the mobile device 140 or remote therefrom. The additional information may be retrieved subsequently to provide maps, guidance, emergency information, or any other suitable information useful to the user of the mobile device 140.

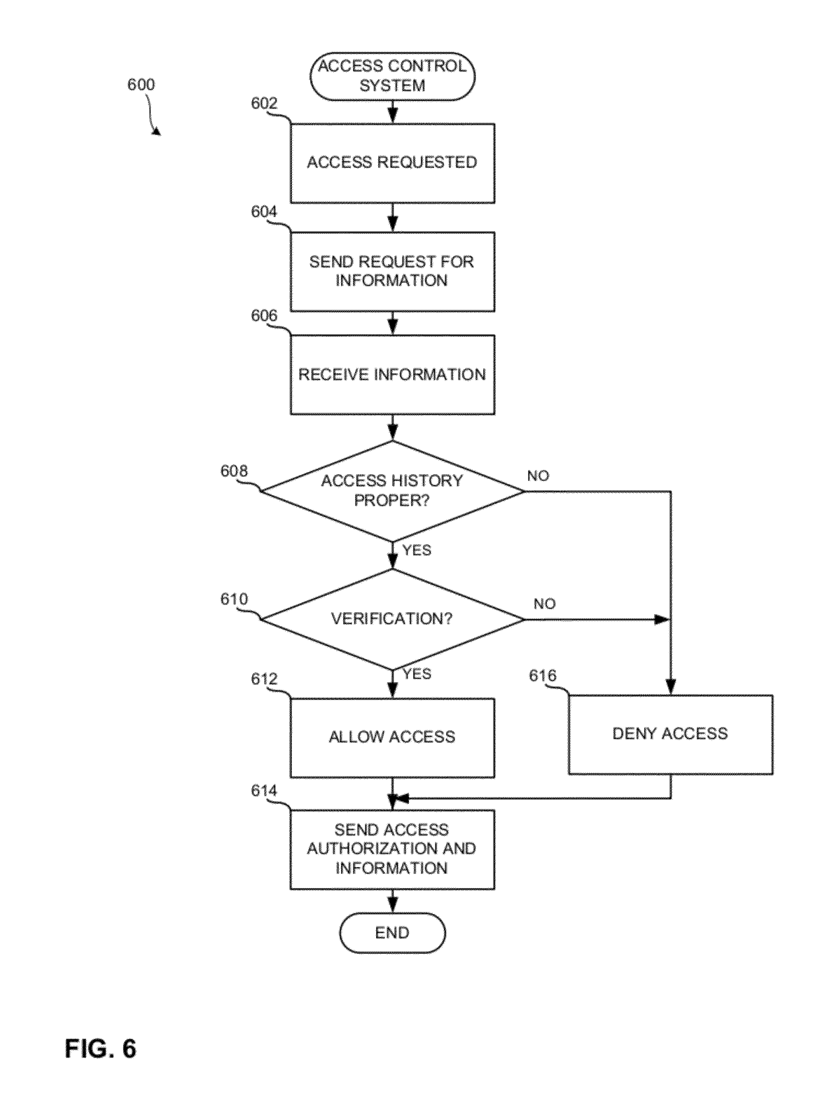

A process 600, as shown in FIG. 6, may be carried out by an access control system, such as the access control system 130 of FIG. 1, FIG. 2, and/or FIG. 4. The access control system 130 determines that access has been requested by the mobile device 140 (block 602). Determining that access has been requested may include, monitoring for presence of the NFC tag 304, which may include periodically sending interrogation signals or any other suitable signals to which NFC tags, such as the NFC tag 304, respond.

When access is requested (block 602), the access control system 130 sends a request for information to the mobile device 140 (block 604). The request for information may include a request for access history, information that may be used to verify authorization to access the area 110, or any other suitable information. In response to the request (block 604), the requested information is received (block 606). The information may be requested and received via the NFC protocol. Alternatively, the access control system 130 may request identifying information from the mobile device and use that identifying information to obtain information such as access history or any other suitable information from a source other than from the mobile device 140. For example, the access control system 130 may utilize the access control data store 206 to obtain access history or other suitable information related to the mobile device 140.

The access control system 130 then evaluates the access history provided by the mobile device 140 to ensure that the access history is proper (block 608). For example, the access control system 130 may evaluate the access history to ensure the mobile device 140 obtained access to areas 102 and 108 from access control systems 122 and 128 prior to requesting access from the access control system 130. The access control system 130 may also evaluate time stamps or other timing information to ensure that the accesses to areas 102 and 108 occurred in an acceptable timeframe prior to the access request (block 602).

If the access history provided by the mobile device 140 is proper (block 608), the access control system 130 determines if verification is proper (block 610). Verification may be carried out based on any desirable criteria. For example, verification may be carried out based on personal information related to the user of the mobile device 140, such as date of birth, driver's license or passport number, home address, social security number, photos, company records, etc. Optionally, for purposes of verification, the access control system 130 may obtain biometric information of the user of the mobile device 140. The biometric may be, retinal scans, fingerprint scans, etc. and may be obtained via the biometric sensor 408.

If the access history is proper (block 608) and verification is proper (block 610), the access control system 130 allows the user of the mobile device 140 to have access to the area 110 (block 612). Access may be granted by unlocking the door 120, opening the door 120, or through any other suitable indication. The access control system 130 also sends access authorization and information to the mobile device 140 (block 614). As explained above, mobile device 140 may store the access authorization for later use as part of an access history. Additionally, the information may include maps, directions, or any other information that may be useful to the user of the mobile device 140.

In the alternative, if either the access history is not proper (block 608) or verification is not proper (block 610), the access control system 130 denies access to the area 110 (block 616). The access control system 130 then sends the access authorization and, optionally, information to the mobile device 140 (block 614). In the case of an access denial, the access authorization would include an indication that access was denied. That indication would be stored by the mobile device 140 and form part of the access history of the mobile device 140.

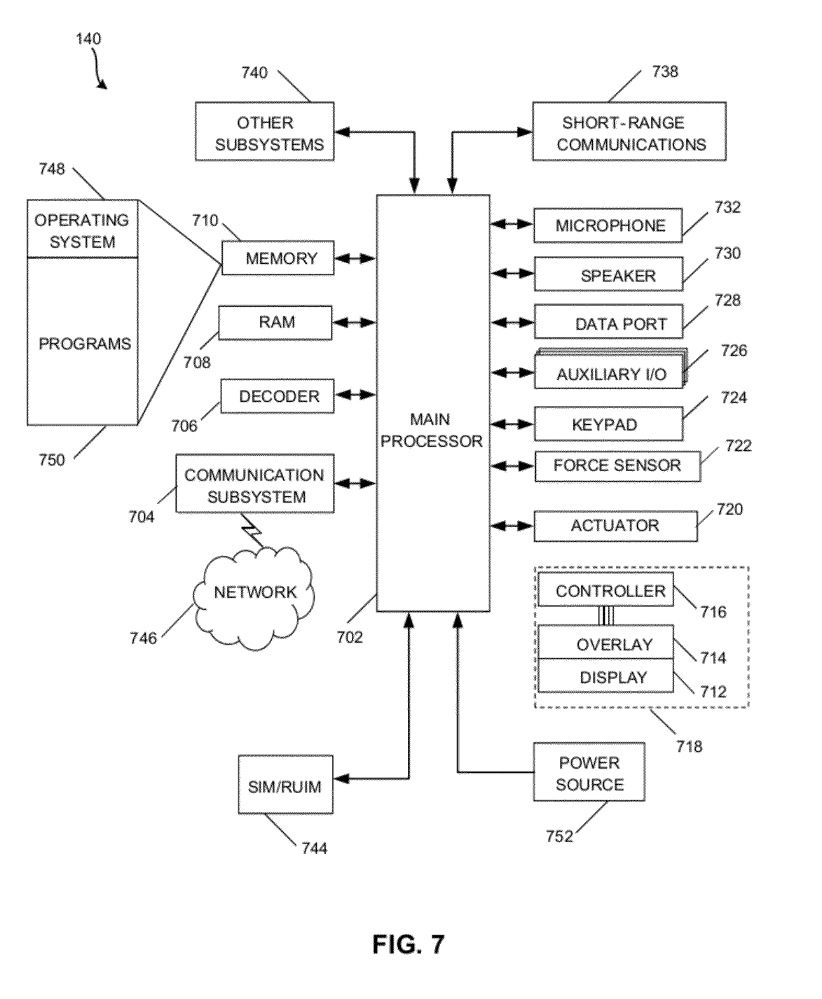

A block diagram of an example mobile device 140, which may be carry out the processes of FIG. 5, is shown in FIG. 7. The mobile device 140 includes multiple components, such as a processor 702 that controls the overall operation of the mobile device 140. Communication functions, including data and voice communications, are performed through a communication subsystem 704. Data received by the mobile device 140 is decompressed and decrypted by a decoder 706. The communication subsystem 704 receives messages from and sends messages to a wireless network 746. The wireless network 746 may be any type of wireless network, including, but not limited to, data wireless networks, voice wireless networks, and networks that support both voice and data communications. A power source 752, such as one or more rechargeable batteries or a port to an external power supply, powers the mobile device 140.

The processor 702 interacts with other components, such as Random Access Memory (RAM) 708, memory 710, a display 712 with a touch-sensitive overlay 714 operably connected to an electronic controller 716 that together comprise a touch-sensitive display 718, one or more actuator apparatus 720, one or more force sensors 722, a keypad 724, an auxiliary input/output (I/O) subsystem 726, a data port 728, a speaker 730, a microphone 732, short-range communications subsystem 738, and other device subsystems 740. User-interaction with a graphical user interface is performed through the touch-sensitive display 718. The processor 702 interacts with the touch-sensitive overlay 714 via the electronic controller 716. Information, such as text, characters, symbols, images, icons, and other items that may be displayed or rendered on the mobile device 140, is displayed on the touch-sensitive display 718 via the processor 702. In some examples, the display 712 may include a primary display and a secondary display.

To identify a subscriber for network access, the mobile device 140 uses a Subscriber Identity Module or a Removable User Identity Module (SIM/RUIM) card 744 for communication with a network, such as the wireless network 746. Alternatively, user identification information may be programmed into memory 710.

The mobile device 140 includes an operating system 748 and software programs or components 750 that are executed by the processor 702 to implement various applications and instructions to carry out processes described herein and are typically stored in a persistent, updatable store such as the memory 710. Additional applications or programs may be loaded onto the portable electronic device 140 through the wireless network 746, the auxiliary I/O subsystem 726, the data port 728, the short-range communications subsystem 738, or any other suitable subsystem 740.

A received signal such as a text message, an e-mail message, or web page download is processed by the communication subsystem 704 and input to the processor 702. The processor 702 processes the received signal for output to the display 712 and/or to the auxiliary I/O subsystem 726. A subscriber may generate data items, for example e-mail messages, which may be transmitted over the wireless network 746 through the communication subsystem 704. For voice communications, the overall operation of the mobile device 140 is similar. The speaker 730 outputs audible information converted from electrical signals, and the microphone 732 converts audible information into electrical signals for processing.

The short-range communications subsystem 738 functionality may be NFC, RFID, or any other suitable short-range or close-proximity communication technology. As described herein, the short-range communication subsystem 738 may be used to facilitate access control.

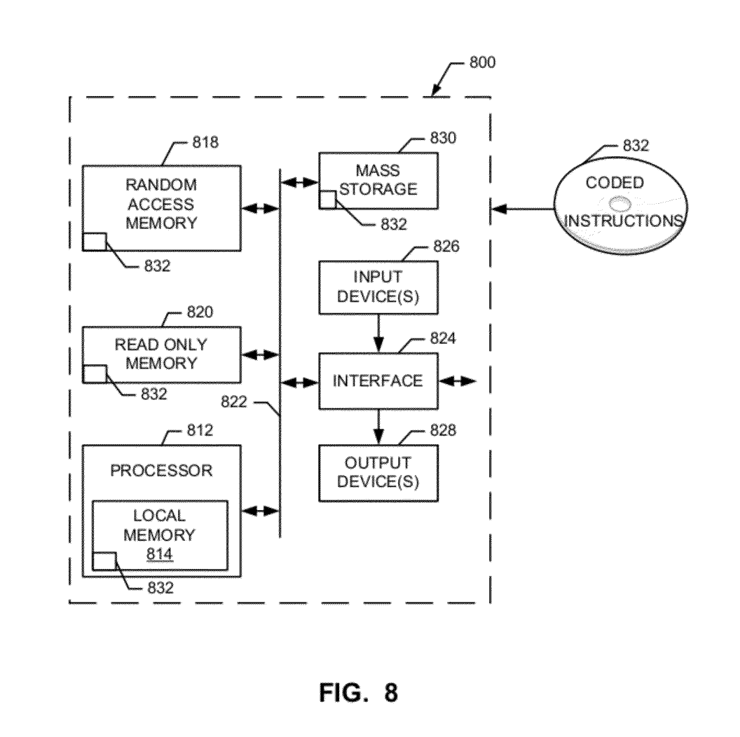

FIG. 8 is a block diagram of an example processing system 800 capable of implementing the apparatus and methods disclosed herein. The processing system 800 can correspond to, for example, a mobile device, an access control system, or any other type of computing device.

The system 800 of the instant example includes a processor 812 such as a general purpose programmable processor, an embedded processor, a microcontroller, etc. The processor 812 includes a local memory 814, and executes coded instructions 816 present in the local memory 814 and/or in another memory device. The processor 812 may execute, among other things, machine readable instructions to implement any, some or all of the processes represented in FIG. 5 and/or FIG. 6. The processor 812 may be any type of processing unit, such as one or more microprocessors, one or more microcontrollers, etc. Of course, other processing devices may be used.

The processor 812 is in communication with a main memory including a volatile memory 818 and a non-volatile memory 820 via a bus 822. The volatile memory 818 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 820 may be implemented by flash memory and/or any other desired type of memory device. Access to the main memory 818, 820 is typically controlled by a memory controller (not shown).

The system 800 also includes an interface circuit 824. The interface circuit 824 may be implemented by any type of interface standard, such as an Ethernet interface, a universal serial bus (USB), and/or a third generation input/output (3GIO) interface.

One or more input devices 826 are connected to the interface circuit 824. The input device(s) 826 permit a user to enter data and commands into the processor 812. The input device(s) can be implemented by, for example, a keyboard, a mouse, a touchscreen, a track-pad, a trackball, an isopoint and/or a voice recognition system.

One or more output devices 828 are also connected to the interface circuit 824. The output devices 828 can be implemented, for example, by display devices. The interface circuit 824 may include a graphics driver card.

The interface circuit 824 also includes a communication device such as a modem or network interface card to facilitate exchange of data with external computers via a network (e.g., an Ethernet connection, a digital subscriber line (DSL), a telephone line, coaxial cable, a cellular telephone system such as an EGPRS-compliant system, etc.).

The system 800 also includes one or more mass storage devices 830 for storing software and data. Examples of such mass storage devices 830 include memories or any suitable data storage devices.

As an alternative to implementing the methods and/or apparatus described herein in a system such as shown in FIG. 8, the methods and or apparatus described herein may be embedded in a structure such as a processor and/or an ASIC (application specific integrated circuit).

Finally, although certain example methods, apparatus and articles of manufacture have been described herein, the scope of coverage of this disclosure is not limited thereto. On the contrary, this disclosure covers all methods, apparatus and articles of manufacture and equivalents described and claimed herein.

What is claimed is:

1. A method comprising:
requesting from a mobile device using close-proximity communication authorization to access a first physical area;
receiving at the mobile device using close-proximity communication authorization to access the first physical area;
requesting from the mobile device using close-proximity communication authorization to access a second physical area inside the first physical area; and
receiving at the mobile device using close-proximity communication authorization to access the second physical area, wherein receipt of the authorization to access the second physical area is dependent upon prior receipt of the authorization to access the first physical area.

2. The method of claim 1, wherein receiving authorization to access the second physical area is also dependent upon prior receipt of authorization to access a third physical area.

3. The method of claim 1, further comprising receiving at the mobile device using close-proximity communication information regarding the first physical area.

4. The method of claim 1, wherein the close-proximity communication comprises near-field communication.

5. The method of claim 1, wherein receiving authorization to access the first physical area comprises authorization to access a plurality of physical areas.

6. The method of claim 1, further comprising indicating from the mobile device that authorization to access the first physical area has been previously received.

7. The method of claim 6, wherein requesting from the mobile device using close-proximity communication authorization to access the second physical area inside the first physical area comprises indicating that the authorization to access the first physical area has been previously received.

8. The method of claim 1, wherein authorization to access the first physical area is received from a first security point and authorization to access the second physical area is received from a second security point.

9. The method of claim 8, wherein the information regarding the first physical area comprises a location of the second security checkpoint.

10. The method of claim 8, wherein the information regarding the first physical area comprises navigation information to the first physical area.

11. The method of claim 1, wherein the information regarding the first physical area comprises a location of the second security checkpoint.

12. The method of claim 1, wherein the information regarding the first physical area comprises navigation information regarding the first physical area.

13. The method of claim 1, wherein the first physical area comprises a building.

14. The method of claim 13, wherein the second physical area comprises an area within the building.

15. The method of claim 1, wherein the authorization to access the first physical area has an associated timestamp.

16. The method of claim 15, wherein the timestamp is evaluated to determine if authorization to access the second physical area should be granted.

17. A mobile device comprising:
a close-proximity communication device; and
a processor coupled to the close-proximity communication device, wherein the processor is programmed at least to:
control the close-proximity communication device to request authorization to access a first physical area;
receive from the close-proximity communication device authorization to access the first physical area;
control the close-proximity communication device to request authorization to access a second physical area inside the first physical area; and
receive from the close-proximity communication device authorization to access the second physical area, wherein receipt of the authorization to access the second physical area is dependent upon prior receipt of the authorization to access the first physical area.

18. The mobile device of claim 17, wherein the processor controls the close-proximity communication device to indicate that authorization to access the first physical area has been previously received.

19. The mobile device of claim 18, wherein the processor controls the close-proximity communication device to request authorization to access the second physical area inside the first physical area comprises by causing the close-proximity communication device to indicate that the authorization to access the first physical area has been previously received.

20. The mobile device of claim 18, wherein authorization to access the first physical area is received from a first security point and authorization to access the second physical area is received from a second security point.
